(19) United States
(12) Patent Application Publication
(10) Pub. No.: US 2016/0307113 A1
(43) Pub. Date: Oct. 20, 2016

(54) LARGE-SCALE BATCH ACTIVE LEARNING USING LOCALITY SENSITIVE HASHING

(71) Applicant: Xerox Corporation, Norwalk, CT (US)

(72) Inventors: Ioan Calapodescu, Grenoble (FR); Caroline Privault, Montbonnot-Saint-Martin (FR); Jean-Michel Renders, Quaix-en-Chartreuse (FR)

(21) Appl. No.: 14/691,136

(22) Filed: Apr. 20, 2015

(51) Int. Cl. G06N 99/00

(52) U.S. Cl. CPC G06N 99/005

(57) ABSTRACT

A system and method for selection of a batch of objects are provided. Each object in a pool is assigned to a subset of a set of buckets. The assignment is based on signatures, generated, for example, by LSH hashing object representations of the objects in the pool. The signatures are then segmented into bands which are each assigned to a respective bucket in the set, based on the elements of the band. An entropy value is computed for each of a set of objects remaining in the pool using a current classifier model. A batch of objects for retraining the model is selected. This includes selecting objects from the set of objects based on their computed entropy values and respective assigned buckets.

### BACKGROUND

The exemplary embodiment relates to active learning in automatic classification and finds particular application in connection with a system and method for active learning using Locality Sensitive Hashing (LSH).

In Machine Learning-based text classification, a statistical model is learned from a training sample made up of annotated texts. This training sample is frequently built through manual review of documents. Active learning is the process of automatically determining what the next document or documents to label should be and to add it or them to the set of training samples. The goal of this selection process is to enhance the classifier performance while reducing the volume of samples to annotate for training a classifier model. This is usually an incremental process: a temporary classifier model is trained from all the labeled samples accumulated at a given stage of the review process. The selection strategy subsequently involves information provided from that temporary model to determine, over the remaining unlabeled set of documents (the “pool set”), what documents should be annotated next. One option is to select a single document at a time, label it, add it to the training set and to immediately retrain a new model before selecting the next sample. For many applications, however, it is often desirable to select a batch of documents at a time. Task crowdsourcing and predictive coding for document review in litigation are examples of applications in which batch selection is advantageous, although other applications where annotation is outsourced or performed by teams often need to employ batch annotation.

In the litigation domain, for example, the document review process is generally a binary classification task which seeks to identify the documents relevant to a case while discarding the rest. A team of analysts and statisticians employ classification tools which rely, for the training set, on documents which have been manually coded by litigation document review teams. The manual review is frequently outsourced to a remote review service, which uses its own tools and software. In most cases, the document review task is spread over different review teams. The manual review service typically organizes the work of reviewers in batches. A reviewer can code between about 300 and 800 documents per day, depending on the review guidelines specific to each case.

In this context, the classification team (analysts and statisticians) may want to apply active learning techniques for training a classifier, but it is unrealistic to ask the review team to code one document at a time. Rather, the team is expected to determine the codes for batches of documents, which are then handed over to the review service. A review supervisor dispatches the documents to the reviewers and, once coded, the batch of labeled documents is returned to the classification team. The classification model is retrained on each batch. Active learning with the retrained model is then used to identify the next batch(es) to be sent for labeling. The batch approach, even if not optimal, still proves to be far more efficient than without any active learning strategy.

In a batch active learning approach, especially for a large-scale review, the selection process should be scalable to document collections of different sizes. Document collections can contain up to millions of documents. Thus, a pool set, at each iteration, can often contain several thousand or several million documents, e.g., up to 20 million documents. Additionally, large document collections often contain a significant number of duplicates or near-duplicates, or even documents related to the same topic. To address this, it would be desirable for the selection process to ensure that it does not produce batches of very similar or duplicate documents, otherwise the model performance will not significantly improve with each batch, while the number of manually coded documents needed will not significantly diminish.

When incrementally creating a batch of K documents out of a pool set of M samples, the selection procedure for adding an i^{th} document to the set {d₁, . . . dᵢ₋₁} of samples in the batch which have been selected so far should ensure that dᵢ will not be similar to any of the (i−1) documents already in the batch. This is commonly achieved by using similarity measures which are calculated between all the M documents in the pool and all the (i−1) documents already in the batch.

The construction of the batch can rely on one or multiple selection criteria. One criterion often used is linked to the “uncertainty” (e.g., measured by the entropy or the margin as computed by the current classifier statistical model) or to the estimated added value of a sample on the performance, if its label were known. Another criterion tries to maintain the diversity of the training set (the training set should span the real operating conditions, as far as possible). This is especially significant in the batch setting. This second criterion is typically based on a (dis-)similarity measure, quantifying to what extent a candidate sample is new with respect to the samples already selected in a batch during its construction. In practice, a hybrid criterion is often used, which aggregates the uncertainty value (or expected added value) with the diversity measure. The MMR (Maximum Marginal Relevance) principle is an example of such a hybrid criterion:

MMR(dᵢ)=H(dᵢ)−βmax[sim(dᵢ,dⱼ), with dⱼ in {d₁, . . . dᵢ₋₁}] (1),

where H(d) is the entropy score derived from the current classifier model estimated probabilities P(c|d), the weight β can be learned on a calibration set, and sim(dᵢ,dᵢ) can be the cosine distance calculated on a bag-of-words representation of the documents dᵢ and dⱼ. At each iteration, all documents in the pool have their MMR score computed and the document with highest score is added to the batch. For a discussion of the MMR approach, see, for example, Jaime Carbonell, et al., “The use of MMR, diversity-based reranking for reordering documents and producing summaries,” Proc. 21st Ann. Intl ACM SIGIR Conf. on Research and Development in Information Retrieval, ACM, pp. 335-336 (1998); Zuobing Xu, et al., “Incorporating diversity and density in active learning for relevance feedback,” Proc. European Conf. on IR Research (ECIR), pp. 246-257, Springer-Verlag (2007); Seokhwan Kim, et al., “MMR-based Active Machine Learning for Bio Named Entity Recognition,” Proc. HLT-NAACL, pp. 69-72 (2006).

Given the number of operations required, however, the MMR approach is generally not tractable for large collections. In particular, the number of similarity measures to compute between document pairs is often prohibitive.

The exemplary embodiment provides a scalable system and method for performing fast and efficient active learning which is suited to large datasets.

### INCORPORATION BY REFERENCE

The following references, the disclosures of which are incorporated herein by reference, are mentioned:

U.S. Pub. No. 20150039538, published Feb. 5, 2015, entitled METHOD FOR PROCESSING A LARGE-SCALE DATA SET, AND ASSOCIATED APPARATUS, by Mohamed Hefeeda, et al., discloses generating a hash value for at least some of the data points in a dataset, sorting the generated hash values into a plurality of buckets of identical or substantially identical hash values, generating a similarity matrix for each of the buckets, and applying a machine learning algorithm to the similarity matrices.

U.S. Pub. No. 20130282721, published Oct. 24, 2013, entitled DISCRIMINATIVE CLASSIFICATION USING INDEX-BASED RANKING OF LARGE MULTIMEDIA ARCHIVES, by Scott McCloskey, et al., discloses a method of performing feature detection on a set of multimedia files which may include utilizing an indexing method based on locality-sensitive hashing for organizing the features.

U.S. Pub. No. 20100312725, published Dec. 9, 2010, entitled SYSTEM AND METHOD FOR ASSISTED DOCUMENT REVIEW, by Caroline Privault, et al., discloses a system and method for reviewing documents in which a subset of documents for which the classifier model assigns a class different from the one assigned based on the reviewer's label is returned for a second review by a reviewer. Models generated from one or more other document sets can be used to assess the review of a first of the sets.

U.S. Pub. No. 20120310864, published Dec. 6, 2012, entitled ADAPTIVE BATCH MODE ACTIVE LEARNING FOR EVOLVING A CLASSIFIER, by Shayok Chakraborty, et al., discloses a method for adaptive batch mode active learning, in which the batch size is determined based on evaluating an objective function.

### BRIEF DESCRIPTION

In accordance with one aspect of the exemplary embodiment; a method for selection of a batch of objects includes, for each object in a pool of objects, performing Locality Sensitive Hashing on a multidimensional representation of the object to compute a signature comprising a sequence of elements. The signature is segmented to form a plurality of bands, each band comprising a subset of the elements in the signature. Each of a plurality of the bands of the signature is assigned to a respective one of a set of buckets, based on values of the signature's elements of the band. This results in assigning each pool set object to one or several buckets in a set of buckets. An entropy value is computed for each of a set of objects remaining in the pool using a current classifier model. A batch of objects is selected. This includes selecting objects from the set of objects based on their computed entropy values and respective assigned buckets.

At least one of the performing Locality Sensitive Hashing, segmenting the signature, assigning the bands, computing an entropy value, and selecting the batch of objects may be performed with a processor.

In accordance with another aspect of the exemplary embodiment; a system for selection of a batch of objects includes a classifier model training component for training a classifier model based on labeled objects. A representation generator provides representations of objects in a pool of objects. An indexing component indexes the objects in the pool based on their signatures, the signatures having been segmented to form a plurality of bands, each band serving as a hash key to retrieve one of a plurality of buckets, the indexing being based on the buckets for which the bands are hash keys. An entropy computation component computes an entropy value for each of a set of objects remaining in the pool using a current classifier model. A batch selection component selects objects to form a batch of objects from the set of objects in the pool. The selection is based on the computed entropy values of the objects and respective assigned buckets. A processor implements the classification component, representation generator, indexing component, entropy computation component, and batch selection component.

In accordance with one aspect of the exemplary embodiment, a method for training a classifier includes providing a current classifier model for labeling objects based on representations of the objects. Representations of objects in a pool of objects are provided. The objects in the pool are indexed based on signatures of the objects, the signatures having been segmented to form a plurality of bands and each band assigned to one of a plurality of buckets, the indexing being based on the buckets to which the bands are assigned. An entropy is computed for each of a set of objects in the pool of objects with the current classifier model, based on the representations of the objects. A batch of objects is selected. This includes selecting objects from the set of objects in the pool to form the batch of objects, the selection being based on the computed entropy values of the objects and respective assigned buckets. The current classifier model is retrained with labels received for the objects in the batch to generate an updated classifier model. This may include receiving labels for the objects in the batch, adding the labeled batch objects to the objects currently in the training set, and retraining the statistical classifier model on the enlarged training set.

At least one of the indexing, computing an entropy value, selecting the batch of objects, and retraining the classifier model may be performed with a processor.

### BRIEF DESCRIPTION OF THE DRAWINGS

FIG. 1 is a functional block diagram of a system for selecting a batch of objects to be annotated for active learning in accordance with one aspect of the exemplary embodiment;

FIG. 2 is a flow chart illustrating a method for selecting a batch of objects to be annotated for active learning in accordance with one aspect of the exemplary embodiment;

FIG. 3 illustrates part of the method of FIG. 2 in accordance with one aspect of the exemplary embodiment;

FIG. 4 illustrates creation of a search index in the method of FIG. 1;

FIG. 5 illustrates S-curves for signatures which have been segmented into different sized bands;

FIG. 6 is a flow chart which illustrates selection of a batch of objects in the method of FIG. 2;

FIG. 7 is a plot comparing computation times for the exemplary method (LSH-with-jumps) with an Entropy-only method;

FIG. 8 is a plot comparing memory consumption for the exemplary method (LSH-with-jumps) with the Entropy-only method;

FIG. 9 is a graph showing F1 measure as a function of number of batches added to the classifier training set, for different batch selection algorithms when the threshold is 0.3; and

FIG. 10 is a graph showing F1 measure as a function of number of batches added to the classifier training set, for different batch selection algorithms when the threshold is 0.6.

### DETAILED DESCRIPTION

Aspects of the exemplary embodiment relate to a system and method suited to large-scale batch active learning for training a machine learning-based classifier. The trained classifier can be used to label objects, such as text documents and/or images. The exemplary active learning method aims to select a set of samples to form the next batch of objects to be labeled in a computationally-efficient manner. While the method is described in the context of legal reviews of text documents being classified for document discovery purposes, it is to be appreciated that the system and method are also applicable to a variety of situations where batch selection is most feasible and desirable during the active learning phase.

The method is particularly suited to large datasets, such as datasets including at least a thousand, or at least a million objects, although it can also be used on smaller datasets.

The method aims to identify a batch of unlabeled objects to be labeled through manual review, which are expected to improve the classifier model when added to the classifier training set, while avoiding having too many objects in the batch which are similar to each other. The choice of objects which improve the classifier model can be based on a measure of entropy. When the entropy is high, this indicates that the current classifier model is unable to predict a label for the object with a high confidence. Objects can be ranked based on entropy. To avoid having too many similar documents, a heterogeneity of the batch is introduced by locality sensitive hashing of representations of the objects to create respective signatures. A search index which identifies a set of buckets to which the signature is assigned is created from the objects in a pool. The search index can be used to favor selection of objects whose set of buckets have not yet been encountered, when iteratively adding objects to the batch.

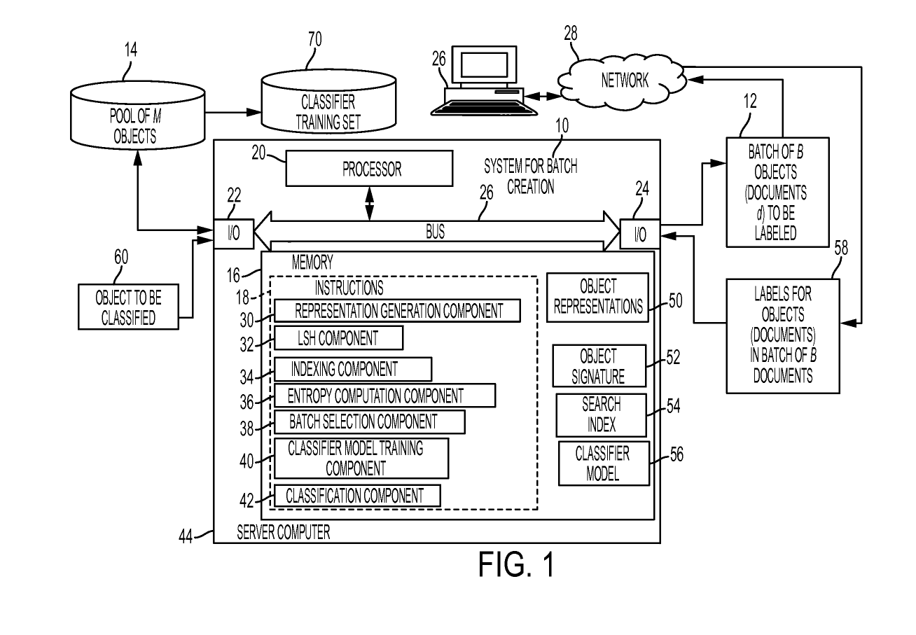

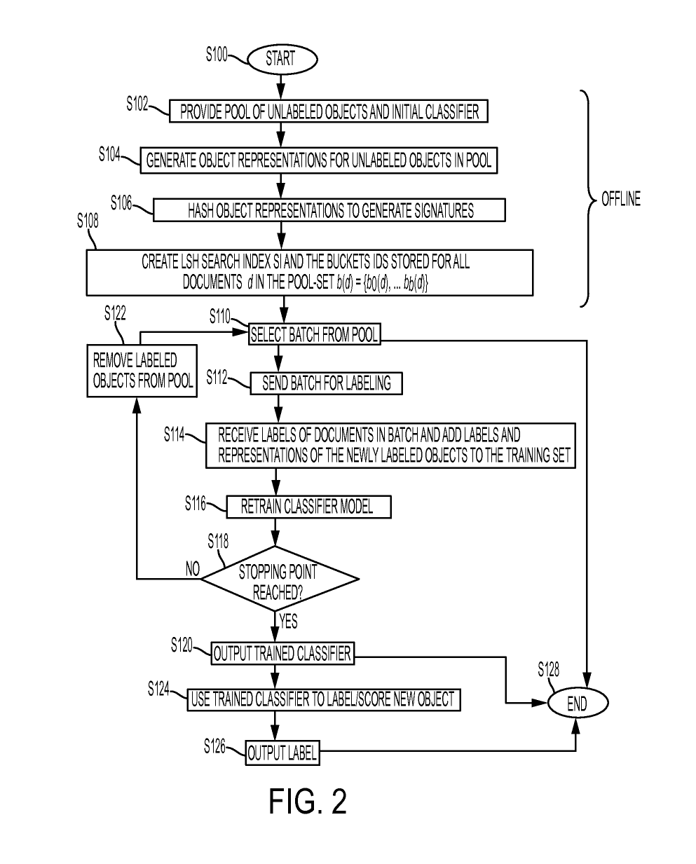

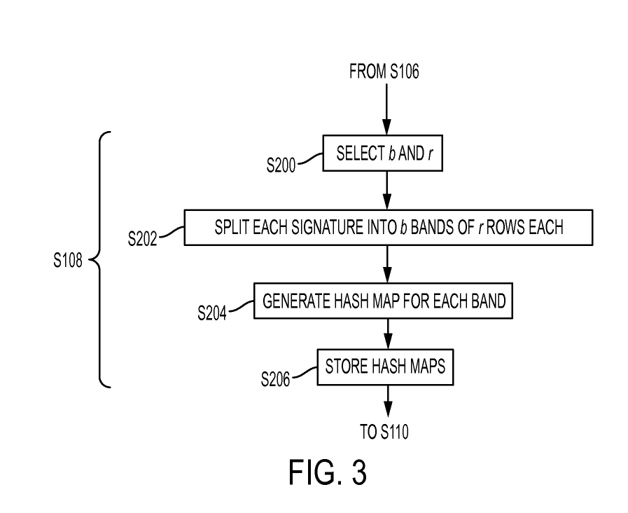

FIG. 1 illustrates a system 10 for creating a batch 12 of B objects, to be output for labeling, where B is at least 2, such as at least 5, or at least 10, or at least 50, and may be up to, for example, 5% or 10% of the objects in the pool. The system has access to a pool 14 of M unlabeled objects (M is much greater than B), which may be stored in memory 16 of the system or in remote memory accessible to the system. In one embodiment, the pool 14 may contain 1 million or more objects, such as text documents, images, videos, or a combination thereof. In the following, the objects are referred to as documents, particularly text documents, although it is appreciated that the method is also applicable to other types of object. Memory 16 stores instructions 18 for performing the exemplary method, which is described with reference to FIGS. 2 and 3. A processor device 20, in communication with the memory 16, executes the instructions 18. One or more input output (I/O) devices 22, 24 allow the system to communicate with external devices. Hardware components 16, 20, 22, 24 communicate via a data/control bus 26. The network interface 22, 24 allows the computer to communicate with other devices 26 via a computer network 28, such as a local area network (LAN) or wide area network (WAN), such as the Internet, and may comprise a modulator/demodulator (MODEM) a router, a cable, and and/or Ethernet port.

The instructions 18 include some or all of: a representation generation component 30, a LSH component 32, an indexing component 34, an entropy computation component 36, a batch selection component 38, a classifier model training component 40, and a classification component 42. These components may be hosted by one or more computing devices 44, such as the illustrated server computer, and are best understood with reference to the method described below. Briefly, the representation generation component 30 generates a document representation 50 for each document, such as a bag of words or n-gram representation in the case of text documents or a Fisher vector in the case of a photographic image. The LSH component 32 generates a signature 52 from each document representation 50. The indexing component 34 generates a search index 54 of object identifiers and corresponding band identifiers for bands b to which each object (e.g., document) d in the pool set 14 belongs, as described in further detail below. The entropy computation component 36 uses an initial classifier model 56 to compute an entropy H (d) of each document d in the pool set 14, relatively to the model 56. The batch selection component 38 iteratively adds documents to the batch 12, based on their computed entropies and band identifiers, until the selected batch size B is reached. The documents in the batch 12 are then output for manual labeling, e.g., sent to a document review service for manual labeling by a team or teams of human annotators. The classifier model training component 40 retrains the initial classifier model 56, based on manually-applied labels 58 given to objects in the batch 12 and representations 50 of the labeled objects. Once the active learning is complete, the classification component 42 can use the (re)trained classifier model 56 to automatically label an unlabeled object (or objects) 60, based on its representation 50. The object 60 to be labeled may be drawn from the pool 14, or otherwise input to the system.

The computer system 10 may include one or more computing devices 44, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 16 may represent any type of non-transitory computer readable medium such as random access memory (RAM), read only memory (ROM), magnetic disk or tape, optical disk, flash memory, or holographic memory. In one embodiment, the memory 16 comprises a combination of random access memory and read only memory. In some embodiments, the processor 20 and memory 16 may be combined in a single chip. Memory 16 stores instructions for performing the exemplary method as well as the processed data 50, 52, 54, 56.

The digital processor device 16 can be variously embodied, such as by a single-core processor, a dual-core processor (or more generally by a multiple-core processor), a digital processor and cooperating math coprocessor, a digital controller, or the like. The digital processor 16, in addition to executing instructions 14 may also control the operation of the computer 30.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

As will be appreciated, FIG. 1 is a high level functional block diagram of only a portion of the components which are incorporated into a computer system 10. Since the configuration and operation of programmable computers are well known, they will not be described further.

FIG. 2 illustrates one embodiment of a method which includes the exemplary batch selection process. The method begins at S100. At S102, access to a pool 14 of unlabeled objects and an initial classifier model 56 is provided. The classifier model 56 may have been initially trained on a set of labeled objects, previously drawn from the pool and manually labeled, or may be a classifier model which has been trained using a prior batch of labeled objects.

At S104, object representations 50 are generated, by the representation generator 30, for the objects in the pool 14.

At S106, the object representations 50 are hashed, by the LSH component 32, with a family of hash functions to generate a signature 52 for each document in the pool.

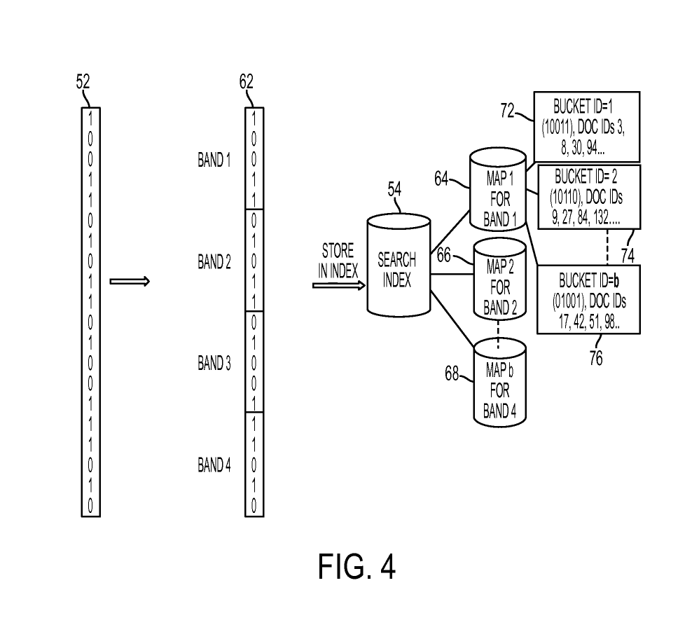

At S108, an LSH search index (SI) 54 is generated, by the indexing component 34, from the signatures 52 and the bucket identifiers for all documents d in the pool are stored: b(d)={b₀(d), . . . , b_{b}(d)}, as illustrated in FIGS. 3 and 4. In particular, the signatures are segmented to form a plurality of bands, each band serving as a hash key to retrieve one of a plurality of buckets, the indexing being based on the buckets for which the bands are hash keys.

Steps S104-S108 can be performed offline.

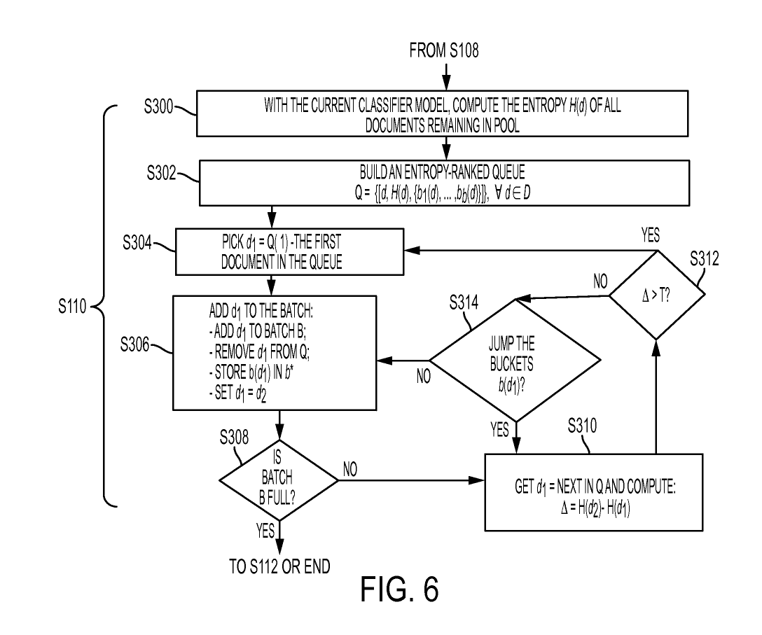

At S110, a (next) batch of B unlabeled documents is selected for labeling from the pool 14, by the batch selection component 38. The selection method is described in further detail with respect to FIG. 6.

At S112, the batch 12 of documents is output for labeling, e.g., to one or more local or remote computers 26, via the local or wide area network 28. The documents are labeled with labels 58 by human annotators and returned to the system. In general, each document is manually annotated with only a single label, which is selected from a predetermined set of labels, each label in the set of labels corresponding to a respective one of a set of classes for which the classifier model 56 is being trained.

At S114, the manually-applied labels 58 for the documents in the set 12 may be received and added to a training set 70 of labeled objects. At S116 the set of labeled training objects may be used, by the classifier model training component 40, to retrain the classifier model 56. At S118, if a stopping point is reached, the method may proceed to S120, where the trained classifier model 56 may be output. Otherwise, if the stopping point has not yet been reached, the method proceeds to S122, where the labeled objects in the batch are removed from the pool and the method returns to S110, this time using the retrained classifier model generated at S116. The stopping point may be a selected classifier performance, no significant improvement in classifier performance, number of iterations reached, or may be based on one or more of these criteria. As will be appreciated, a large number of batches may be created in this way for iteratively retraining the classifier model, such as at least 10, 20, 50, 100, or 200, or more batches.

At S124, the trained classifier model 56 may be used, by the classification component 42, to label a new object 60, such as some or all of the remaining objects in the pool, or a new object not initially in the pool. At S126, the label is output.

The method ends at S128.

Further details of the system and method will now be provided.

### Object Representation Generation (S104)

Prior to applying the locality sensitive hashing, each document in the pool 14 is transformed into a vector representation 50 (S104). This can be generated for text documents using n-grams, which are sequences of n symbols, where the symbols may be characters or words, or using a bag-of-words (often, a set of the more discriminative words).

The representation generation (S104) may proceed as described above, i.e., each document (object) is transformed into a vector representation. In one embodiment, the document representation is based on n-grams, where the representation includes, for each of a set of n-grams, a value representing the occurrence of the n-gram in the document. The occurrence may be a normalized count, i.e.,

$$\frac{count of the n \text{-} gram in the document}{total count of all n \text{-} grams in the document}$$

where n may be for example, at least 2, such as from 3-10 symbols in sequence, where the symbols may be characters or words. For example, the counts of a set of 2-to-5-grams may be computed. In another embodiment, the vector is based on a bag-of-words, where for each word, a value representing the occurrence in the document (e.g., presence or normalized count).

The type of document representation used is dependent, to some degree on the type of hash function used. For example, a bag-of-words representation is particularly suited to hash functions based on the cosine similarity. The document representation may be based on words extracted from all or a portion of the document, such as the first 1000 words.

### Locality Sensitive Hashing (S106)

In the exemplary embodiment, the vector representation 50 of the object, generated at S104, is hashed multiple times though the selected family of k hash functions, to obtain a signature 52 of size k. In the exemplary embodiment, an adaptation of Locality Sensitive Hashing (LSH) is used for this step.

The goal of the present LSH method is to hash documents into buckets, expecting that the most similar or near-duplicate documents will hash into the same bucket(s). This is the opposite of a classical hash function where the aim is to avoid collisions between similar inputs.

In LSH, the data is projected into a low-dimensional space where each data point is mapped to a vector called a signature 52. The signatures can then be assigned to one of a plurality of buckets. Similar input objects are thereby mapped to the same buckets with a high probability. See, for example, J. Leskovec, et al., “Mining of Massive Datasets,” online publication (2014), hereinafter, “Leskovec”). This is achieved using a hashing family K, or set of k hash functions, where each hash function must satisfy the locality sensitive hashing property defined on a space R with a given distance measure d:

A family K of hash functions is said to be (d₁, d₂, p₁, p₂)—sensitive if for any x and y in R:
a. If the distance between objects x and y, d(x,y)≦dᵢ, then for all hash functions k in K: the probability that the hash of x is equal to the hash of y is at least equal to pᵢ, the recall rate, i.e., p[k(x)=k(y)]≧p₁; and
b. If the distance d(x,y)≧d₂, then for all k in K: p[k(x)=k(y)]≦p₂, the collision error rate.

Similarly, statements a) and b) can be expressed in terms of similarity, i.e., if the similarity sim(x,y)≧s₁, p[k(x)=k(y)]≧p₁ and if the similarity sim(x,y)≦s₂, then for all k in K: p[k(x)=k(y)]≦p₂. In both forms, the recall rate p₁ is expected to be greater than the collision error rate p₂.

In selecting the family of hash functions to be used (e.g., based on a training set of objects), the (d₁,d₂,p₁,p₂)—sensitive criteria a) considers only those objects with a high probability of collision (low distance/high similarity between them) and requires selection of a family of hash functions which provide a high probability that these will be assigned to the same bucket, while the (d₁, d₂, p₁,p₂)—sensitive criteria b) considers only those objects with a low probability of collision (high distance/low similarity between them) and requires a family of hash functions which provide a low probability that these will be assigned to the same bucket. Both criteria are met in the family of hash functions which are selected for use in the method.

The distance (or similarity) can be, for example, the cosine distance, Hamming distance, Jaccard similarity, or the like. The Jaccard similarity (or Jaccard Index), for example, measures similarity of two sets as the ratio of the size of their intersection to the size of their union. LSH family implementations are available for Hamming distance (bit sampling), Jaccard Similarity (MinHash, SimHash) and Cosine (Random hyperplane hashing). For example, MinHash is an LSH family for the Jaccard index. See Andrei Z. Broder, “On the resemblance and containment of documents”, Proc. Compression and Complexity of Sequences, IEEE, pp. 21-29 (1997). The MinHash is used to compute an estimate of the Jaccard similarity coefficient of pairs of sets, where each set is represented by an equal-sized signature derived from the minimum values of the hash function. Random projection is an LSH family for the Cosine similarity. See Moses S. Charikar, “Similarity Estimation Techniques from Rounding Algorithms,” Proc. 34th Ann. ACM Symp. on Theory of Computing, pp. 380-388 (2002).

Thus, given the selected family of hash functions, the representation 50 for each document in the pool 14 is hashed with each function in the family to generate a hash, and the set of hashes for the document are combined, e.g., concatenated, to form a multidimensional signature 52 of length k. k may be, for example, at least 32, or at least 64, or at least 128, or at least 256, and may be up to 4000 in some embodiments.

As will be appreciated, directly approximating document similarities by performing pairwise comparisons of document signatures 52 could be performed (e.g., using the Hamming distance). This would be an alternative to the usual computation of similarity measures, such as the cosine similarity, e.g., based on document bag-of-words representations. However a pairwise comparison on the signatures 52 is still too slow for large pools 14. For example, if there are initially 5M documents in the pool and if a similarity approximation is performed in 1 millisecond, then to compute the similarity between a document from the batch and all the documents in the pool would take about 83 minutes. Repeating this calculation for each new document to add to the batch would be impracticable.

### Creation of Search Index (S108)

The scale of similarity-based methods (e.g., Maximum Marginal Relevance (MMR)-based methods) can be improved, for example, by seeking faster-to-calculate similarity measures, or caching intermediate results of similarity calculations. However, the number of operations still remains too large to cope with datasets of at least 1 million documents. Furthermore, calculating the value of the similarity measure between documents (either through their signatures or other vector representations) is not a goal in itself. Rather, the similarity value is only used as a means to introduce some heterogeneity in the selection. Its actual value is unimportant.

In the exemplary method, computing document-to-document similarity measures is avoided. Although based on LSH, the exemplary method employs neither the similarity approximation nor the approximate nearest neighbor (ANN) search algorithm commonly associated with LSH.

The way in which LSH is used in the exemplary method makes the batch active learning process (S110-S116) computationally feasible without degrading the overall classifier performance (compared, for example, to the MMR-based method). Test results indicate that the exemplary method outperforms the MMR-based method in more than 50% of the cases (as measured by the F1 criterion after annotating a given number of documents). Alternatively, the method allows reducing the number of documents to be annotated for a fixed level of classifier performance.

With reference to FIGS. 3 and 4, the search index 54 can be built (S108) as follows:

At S200, values of b (number of bands) and r (number of rows in each band) are selected, such that b*r=k, the size of the signature.

At S202, for each signature 52 generated at S106, the signature is split, as shown at 62, to form b bands of r rows each (where b*r=k, the number of elements in the signature). b and r may each be, for example at least 2, or at least 3, or at least 4, or at least 5, depending on the size of the signatures 52. In one embodiment, b # r, although this case is not excluded. The hash signature 52 is segmented into equally sized segments which are k/b in length. For example, the first five elements of the signature 52 (first segment) are entered into the first band b=1, then the next five elements form the second band, and so forth for the rest of the bands.

At S204, each band b becomes an entry in a separate hash map 64, 66, 68, etc. (i.e., key-value pairs with key=band b of signature of docID; value=bucket ID). Each bucket 72, 74, 76, etc. in the hash map 64 is a set of documents d or, more generally, objects that all have identical values of the signature in the same band. This is an “AND” condition for the equality over r values). Thus for example, map 1 may store the set of documents that have the same set of elements in their first band. In the case of exemplary signature 52, its first band is (1,0,0,1,1). So the document, as identified by its document identifier (docID), will be stored with other documents having that same set of elements for their first band, i.e., in the same bucket 72, which is identified by a bucket identifier (bucket ID). Another document may have (0,1,0,0,1) as its first band, so it is stored in a different bucket 76 in map 1. Map 2 stores similar buckets for the second band, and so forth up to band b. Thus every document (docID) appears in each of the hash maps 64, 66, 68, etc. but appears in only one of the buckets in each of the hash maps 64, 66, 68, etc. The hash maps are stored at S206. The method may then proceeds to S110.

A set of b hash maps 64, 66, 68, etc. is thus obtained, each containing different buckets of documents. In this method, the same document d will appear inside a bucket for each hash map. The expectation is that similar documents will fall into the same buckets within the different hash maps. The choice of b and r is a trade-off which is guided by a suitable sensitivity/specificity analysis (often referred to as the S-curve). For a fixed signature size k, the split in b bands and r rows impacts the S-curve (of the LSH family). Choosing r and b is equivalent to the creation of a new LSH family G by AND/OR amplification from the original family K (p[k(x)=k(y)]=sim): e.g., OR: (p[g(x)=g(y)]=1−(1−sim^{r})^{b}).

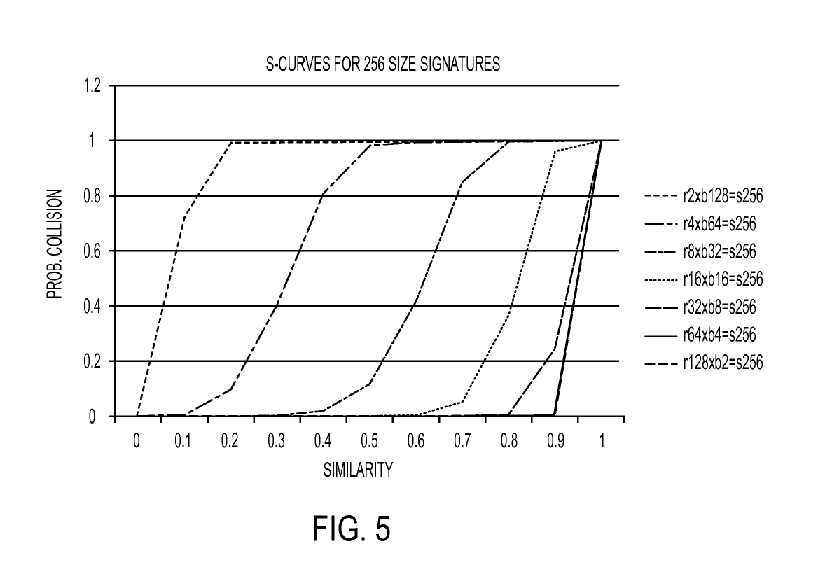

For example, some OR amplifications for a 256 LSH family are shown in FIG. 5.

As will be appreciated the total number of buckets can be quite large, and is generally much larger than b, such as at least 5×b or at least 10×b. However, the number of buckets is generally less than the number M of documents in the pool, such as no greater than ¼ or no greater than ½ or no greater than 1/10 of the number of documents in the pool, ensuring that at least some, e.g., a majority (at least 50%) of the buckets include more than one document identifier. The number of buckets generally increases with the number r of elements. However, the search index 54 is only created once and need only assign bucket IDs to the documents that are observed in the pool. Once each document in the pool has its own list of bucket IDs, it is no longer necessary to keep or store in memory the content of each bucket, that is the list of documents constituting each bucket. To create the search index 54, it may take approximately 10 minutes to index a 700,000 document corpus (such as the full Enron data set), with the Random Projections hash family for Cosine (256 bit hash signatures, giving 8 rows and 32 bands). This amount of time is generally not significant since the indexing operation need only be performed only once per pool 14, just before entering the review process.

### Selection of Next Batch of Documents to be Labeled (S110)

As discussed above, the LSH search index 54 is created off-line for the entire set of objects initially in the pool 14, and for each document in the pool, only the bucket identifiers it belongs to b(d)={b₁(d), . . . , b_{b}(d)} for each of its bands are kept, where b₁(d) is the bucket ID for the first band, and so forth up to the last band's bucket ID, b_{b}(d).

With reference now to FIG. 6 and the pseudo-code shown in Algorithm 1, the batch selection process in S110 may proceed as follows:

At S300, using the current classifier model 56, the entropy H(d) for all documents remaining in the pool is computed, e.g., by the entropy computation component 36. The entropy H(d) of each document in the pool set relative to the classifier model 56 can be computed as follows:

H(d)=−Σ₁^{c}P(c|d)log_{c} P(c|d) (1)

where c represents a class and P(c|d) represents the probability assigned for that class by the current classifier model for the object d. The P(c|d) vales may be retrieved by the classification component 42. There may be any number of classes c, such as 2, 3 or more, depending on the type of classifier model. For a binary classifier that is uncertain as to which of two classes to assign to an object, the probability for each class may be about 0.5, resulting in an entropy close to 1. Where the classifier is more certain, the entropy will be less than 1.

Eqn. 1 sums the function over all classes (the minus sign may be omitted from Eqn. 1 and objects ranked by increasing value of the Eqn. in the next step, or by another function thereof).

At S302, a ranked queue Q containing the document identifiers (associated with their respective entropies and bucket IDs in the LSH index 54) is generated. These three pieces of data form the queue that will be read to populate the batch: the document identifier, its entropy, and the set of b buckets to which it belongs, for each document in the pool:

Q={[d,H(d),{b₁(d), . . . ,b_{b}(d)}]},∀d in the pool

This queue is sorted by decreasing value of entropy H(d).

The steps S300 and S302 are preliminary steps where the data to perform the main active learning selection loop is generated. As can be seen, even for very large collections, most of the data can fit in memory for fast processing (for a given document d only its document identifier (docID), the entropy value H(d), and the set of buckets IDs (one buckets ID for each band) are stored).

At S304, a first document d₁ is drawn from the pool 14, such as the first document in the Q (i.e., the one with the highest entropy). S304 is used to initialize the selected documents in the batch (the first document in the batch is always the one with the highest entropy in the exemplary embodiment). This step is also used as back-off when reaching the threshold, as described for S312.

At S306, the document d₁ is added to batch B. This includes adding the document d₁ to the batch, removing it from the queue Q, adding its set of buckets to the list of buckets already seen, denoted b*, and d₂ receives the value of d₁ (set d₂ d₁).

At S308, if the batch B is full, the method proceeds to S112 or the end. Otherwise, if the batch is not full, the method proceeds to S310.

At S310, a new document, such as the next document d₁ in Q (more precisely, ‘next’ refers to a queue forward iterator; it returns a pointer to the next element in the queue, without removing this element from the queue) is retrieved. The difference in entropy between the new document d₁ and d₂ (or any previously added document) is computed: Δ=H(d₂)−H(d₁). S310 thus starts the real active learning loop by picking documents in the queue and by computing the possible loss in entropy Δ.

If at S312, Δ>T (a threshold), the drop in the entropy is considered too large. The method then returns to S304, where the method backs-off to the “best” entropy, i.e., instead of picking a next document in the queue, goes up in the entropy queue and selects the document remaining in the queue which has the highest entropy, if there is one. Otherwise, if Δ≦T, the method proceeds to S314.

In some embodiments, at S310, the next document is simply drawn from the queue and no measure of entropy difference is computed. In this embodiment, the method proceeds directly from S310 to S314 (this corresponds to setting the threshold T at a maximum entropy difference, e.g., T=1).

At S314, the method checks whether to jump forward in the entropy queue rather than adding d₁ to the batch. Based on the comparison of the buckets of the document d₁ with the set of already seen buckets of previously added documents, a determination is made as to whether to add the document d₁ to the batch. This may include checking if d₁ has some buckets in common with b*, that is all buckets from all previously selected documents currently in batch B (i.e., added at prior iteration(s) of S306). This checks whether at least some of the document d₁'s buckets have already been seen during the creation of the batch. This step effectively jumps inside the LSH index when following the entropy trail. Thus, if the check is true (a least a threshold amount (number or proportion) of buckets in common with the buckets already seen), then the document d₁ is probably very similar to the already selected documents in the batch, therefore the method returns to S310 and jumps forward in in the Q to select a another document from the pool. If untrue (few or no buckets in common), d₁ is the new candidate for the batch. The method proceeds to S306, where d₁ is added to the batch B. All the buckets of this newly-added document d₁ are added to the list of already seen buckets b*. Document d₁ is removed from the queue Q and d₂ receives the value of d₁ (to be used at the next iteration of S310). S306 prepares for the next loop on the remaining documents in the pool.

In S314, therefore, the bucket IDs {b₁(d), . . . b_{b}(d)} from the documents d currently in batch B, which have been collected through the different buckets of the search index, are used to check that the current candidate document is not similar to the documents previously added to the batch B. Doing so may reject a lot of documents before a document is found that does not belong to a cluster holding documents currently in the batch. But each time a document is rejected and the next one in the queue is considered, a decrease in entropy is observed (documents are queued by decreasing value of entropy). Therefore the combination of the threshold T and comparison of buckets is used to make sure that a document is not going to be added to the batch which is indeed dissimilar from the batch ones, but at the same time, is not useful for improving the model (because it is already well discriminated by the classifier model, i.e., with low entropy). For example, if document d₁ has a list of buckets (3, 36, 64, 96) and the buckets of documents already added are (3, 4, 12, 19, 35, 38, 42, 54, 63, 72, 81, 89, 98, 102, 108, 114), and if the threshold on similar buckets is 1, then the single matching bucket “3” is not sufficient to exclude the document d₁ from the batch, and it is added at S306. Its buckets are then added to the list b* of already seen buckets.

The method proceeds from S306 to S308, where if B is full, or if the queue is empty, then S110 ends, otherwise the method returns to S310.

In the step S308, the end of the queue Q may have been reached (i.e., the forward iterator ‘next document’ is no longer defined) with an incomplete batch (i.e., when the number of selected documents is less than expected). In this embodiment, a different method may be used to select documents for the batch. For example, in one embodiment, the batch may be completed with entropy ranked documents, i.e., based on entropy alone. This case is rare, however, since the aim is generally to be able to train the classifier model on much fewer than all the documents in the collection. Experimentally, in tests on 800,000 documents with 256-bit hash signatures and 80,000 buckets, the case was never observed. In another embodiment, the remainder of the batch may be selected randomly from the remaining documents in the pool.

ALGORITHM 1

```
Function BuildBatchLSH
Inputs:
- LSH Search Index (list of tuples <docID(d),b(d) = {b₁(d),...,b_{b}(d)}>),
where bᵢ(d) is the bucket index of object d for band i and b(d) is the set
of bucket indices of d for all bands
- Uncertainty or Added Value Vector, for all objects of the poolset: H(d)
- T: a threshold on the max acceptable difference in H(d)
- B : the desired BatchSize
Outputs:
-a list L of docIDs (ranked by decreasing order of priority)
Algorithm:
(1) Build the ranked queue Q of tuples <docID(d),H(d),b(d)>, sorted by
decreasing order of H(d) values
(2) Initialization:
    L= ø /* Batch List
    b*=ø /* set of already visited buckets
    d₁ ←first(Q) /* [forward unidirectional] iterator pointing to the
first element of Q
    d2 ←d1 /* backup of first element of Q
(3) while (card(L)<B) AND (d₁ exists)
  (3.a.) if H(d₁) > H(d₂) − T AND b(d₁) ∩ b* = ø /* both the diversity and
uncertainty drop conditions are fulfilled
  push(d₁,L)
  Hd₂ = H(d₁)
    remove(d₁,Q)
  Else if H(d₁) ≦ H(d₂) − T /* unacceptable uncertainty drop
  r ← dequeue(Q)
  push(r,L)
  Endif
  (3.b) d₂ ← d₁ /* backup of d1
    d₁ ← next(d,Q) /* d now points to the object which follows the
previous one in Q,
Endwhile
(4) if list(L)<B AND (d does not exist)
  While list(L)<B
        R ← dequeue(Q)
        push(r,L)
```

As will be appreciated, the method illustrated in FIG. 6 can be modified in various embodiments. The following are illustrative examples:

### 1. Delta Computation

In one embodiment, when calculating the loss of entropy for a new candidate document d₁, the Δ on H(d) can be computed with reference to the document preceding d₁ in the queue, instead of comparing Δ as a function of H(d₁) and H(d₂).

### 2. No Delta Computation

In another embodiment, the method proceeds without any delta threshold T. Computation of Δ can be avoided while still keeping the safety of a back-off in the following way. A specific LSH index is created in which the number of buckets can be the sole decision maker. As can be seen on the LSH S-curves (FIG. 5), reducing the number of bands, while keeping the signature size constant in order not to degrade the LSH characteristics, allows having finer-grained buckets. This means that it is less likely that two documents will be in the same bucket, except for when they are very similar. Consequently, there are more chances to accept a document when traversing the queue, avoiding the need to rely on the entropy difference criterion to avoid going down too far down the queue.

It should be noted that limiting the number of bands does not necessarily degrade the LSH characteristics of the index (it is the combination of bands and rows that give the final collision probabilities). See the LSH S-curve definition in Leskovec.

### 3. Parallelizable Workflow

The complete algorithm can be parallelized to provide horizontal scalability, by performing computations across several “servers” or working nodes.

This distribution of a batch of size B, from a pool of M documents, between the W working nodes, starts by performing an equally-sized partitioning of the entire pool 14. This partitioning step can be performed after the entropy computation or even randomly (this latter option allows parallelizing the entropy computation and/or the LSH index creation inside the cluster). The parallelization method amounts to executing the LSH-based batch building algorithm on each of the W nodes on M/W documents and, optionally to execute the algorithm once again on a merged set of candidates returned by the W nodes.

As for the single node case, the entropy can be computed locally by each node without any synchronization problem (i.e., the entropy of a given document only depends on the categorization model, not on any other document).

As for the entropy, the LSH index creation can be distributed across the nodes (with the LSH family being initialized with the same random seeds). Each local LSH index is only keeping track of its local documents.

After the partitioning, the LSH index creation and the entropy computation, each working node sorts the local documents by entropy (to obtain the same queue structure described for the single node case).

From there, each node can follow the main algorithm, e.g., without the threshold back-off policy. In the case of a partitioning where the entropy is pre-computed and the partitions are made by sorted entropy, the use of threshold T can be kept. At the end of this step, each local node may produce, as output, B candidates (the same number as the full batch, if enough candidates are available in the partition). The list of candidates is sent to a merge server, together with other intermediate results (the entropies, if the node has computed them, the list of visited buckets, etc.).

The merge server then merges and sorts all the entropies (to have the documents sorted by entropy) and all the W×B candidates. The merge server applies the algorithm one more time on this merged set of candidates, the global entropy listing being used as a fall-back, as previously.

The multiple node algorithm provides the same results as the main (single node) algorithm because, in the worst case, the candidates will contain duplicate buckets (i.e., documents from the same buckets) and/or candidates with too low entropy. But these weak candidates will simply be filtered out by the last step where the complete algorithm is applied (with threshold back off and bucket filtering).

### Classifier Training

The classifier model 56 may be initially trained on representations of a randomly selected set 70 of documents which are withdrawn from the collection and then manually labeled. The remainder of the unlabeled documents can then form the pool 14. When a new batch of documents which have been labeled by the human annotators is returned to the system (S114), the labeled documents are added to the classifier training set 70 and removed from the pool 14. The classifier model is then retrained using all (or at least some) of the labeled training objects in the set 70 (S116). Specifically, a classification function is learned which best fits the labels and representations 50 of the objects in the training set. As will be appreciated, rather than using the same representations that are used for generation of the signatures, another type of multidimensional vectorial representation of the objects can be used.

Once the classifier model has been retrained, the entropies of the objects remaining in the pool 14 are recomputed (S300) using the current (retrained) classifier model, before selecting the next batch from the pool.

The method illustrated in one or more of FIGS. 2, 3, 4, and 6 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 44 (for example, an internal hard drive of RAM), or may be separate (for example, an external hard drive operatively connected with the computer 44), or may be separate and accessed via a digital data network such as a local area network (LAN) or the Internet (for example, as a redundant array of inexpensive of independent disks (RAID) or other network server storage that is indirectly accessed by the computer 44, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in one or more of FIGS. 2, 3, 4, and 6, can be used to implement the method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

Automated text classification finds application in various domains. It can be applied to many real world situations and embedded in a wide range of industrial applications and services, such as eDiscovery, particularly for identifying documents for document review in order to train a classifier model to perform the same operation. Large-scale batch active learning finds a direct application in the reduction of the manual review costs and contributes to the feasibility of automating the review process.

Without intending to limit the scope of the exemplary embodiment, the following Examples illustrate application of the method to large document collections.

### Examples

The collections used included Reuters Corpus V1 (RCV1) (800,000 documents, all annotated), Enron (700,000 documents, partially annotated) and two other collections (with respectively 1.5 million documents and 0.5 million documents).

The value of the threshold T on Δ was varied in the range: {0.0, . . . , 0.6}. For the LSH family, random projection (for the Cosine similarity) was used to generate 256-bit hash signatures. A default of 8 bands and 32 rows was used in generating the search index 54.

The following algorithms were compared:

A1. LSH-With-Jumps: the exemplary algorithm 1, using a threshold T,

A2. Entropy: an entropy-only method, where only the entropy part of the exemplary method was used, without using the heterogeneity constraint introduced by LSH,

A3. MMR-Random, a MMR method with randomly selected batches, and

A4. MMR-Approx. (in which an MMR formula was used but with an LSH-based approximation of the document pairwise similarity).

Initial classification models: samples were randomly chosen from the collection for generation of the models and excluded from the pool.

Batch size: different batch sizes were tested, from small batches of 10 documents up to 1000 (10, 20, 50, 100, 500 and 1000 documents).

Pool size: pools of different sizes were considered.

Evaluation: an initial training set of documents was created and removed from the collection (not used in creating the pool). From the documents remaining in the collection, a test set of 10,000 documents was randomly created. This also was removed from the collection (not used in creating the pool). The pool is thus devoid of any training data or testing data. For a pool of remaining documents, batches were iteratively computed. At each iteration, the new batch (and document labels) was then added to the training set, and used to retrain the classifier model. The newly created classifier model was evaluated on the test set. For each newly created classifier model, the F1 measure was computed. In the next iteration, the new classifier model is used compute the next batch, and so on, until there are no documents left to select from the pool (so called “repeat-mode”).

The method was implemented in Windows 7 (4 cores, multi-threaded, 8 GB memory, 4 GB allocated to the JVM, SSD disk) and Linux CentOS 6 (2×4 cores, multi-threaded, 36 GB of memory, 10 GB allocated to the JVM, NFS disks).

### Evaluation of Computation Time and Memory Usage

For measuring computing time for a single batch:

T=0.25 as threshold for the jumps (or β for the MMR)
a. a batch size of 1000 and 2000 documents
b. 781,264 document pool from Reuters Corpus Volume 1, GB of data (other collections were also tested).
c. Initial set of 100 documents randomly chosen and excluded from the pool

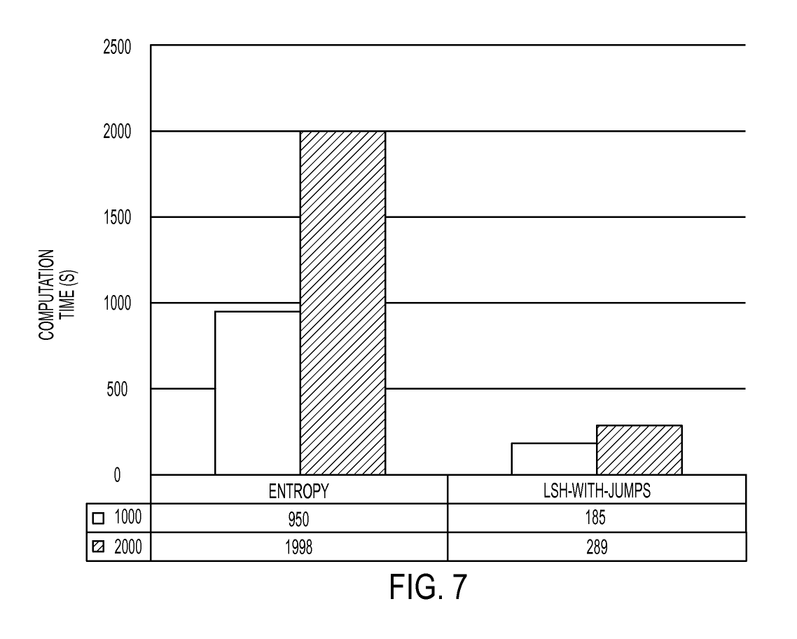

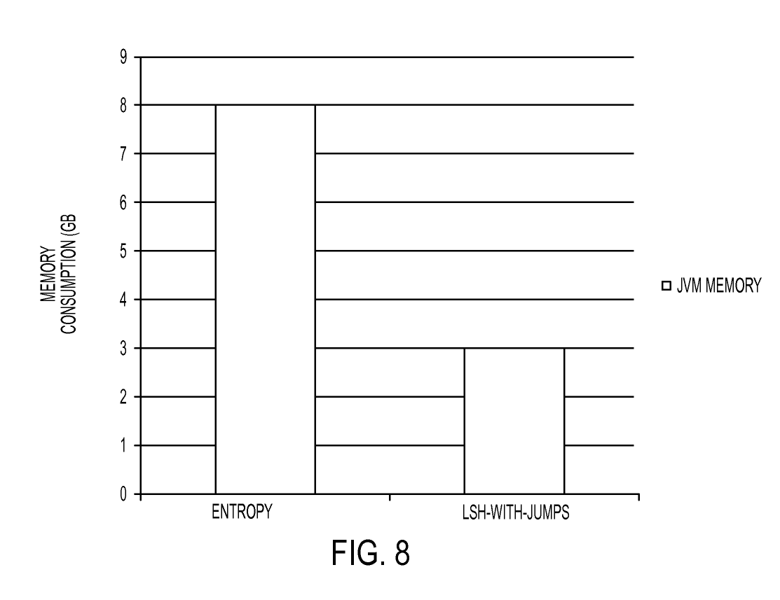

FIGS. 7 and 8 show the computation time (in seconds) and memory consumption (in GB) for an evaluation of the algorithms LSH-with-Jumps and Entropy only method, performed on a Linux CentOS 6 server (2×4 cores, multi-threaded, 36 GB of memory, 10 only allocated to the JVM). Similar experiments have also been conducted on Windows platforms.

A decrease of 5 to 6 times in computing time is observed when using LSH-With-Jumps (FIG. 7). This method also incurs a lower memory footprint (FIG. 8).

### Performance Evaluation

Reusing the same parameters as in the first evaluation of computation time and memory usage, the impact on the F1 measure

$$( 2 \times \frac{precision \times recall}{precision + recall} )$$

was evaluated when performing the active learning with different algorithms. The active learning is performed in the “repeat-mode” by repeating the active learning until all the documents in the pool are selected, to see how the new classifier model's F1 is impacted by each addition of a batch of documents.

For twenty different experimentations (variations of batches, pool sizes, β or T . . . ) it was found that the LSH-With-Jumps algorithm outperforms the MMR-Random selection and the Entropy methods. When comparing LSH-with-Jumps with Entropy, in 68% of the experiments, the exemplary LSH-With-Jumps Algorithm gives the best F1 while in 32% of the evaluations, the Entropy method gives the best F1. The MMR-Random selection was never observed to be better than the others in these experiments.

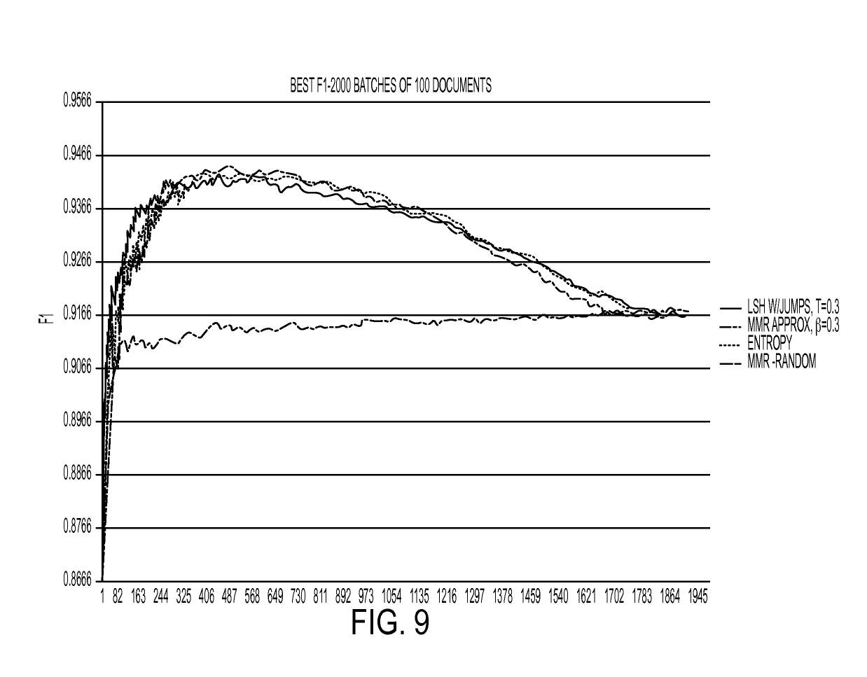

Additionally, in the first batches of 100 documents, the LSH-with-Jumps is better than the MMR-Approx. method, as shown in FIG. 9, which is a typical best F1 curve.

As can be seen from FIG. 9, the performance of the classifier model improves rapidly with the exemplary LSH method, but after a number of batches have been added for retraining the classifier model, begins to degrade (probably due to overfitting to the data). Thus, it is suggested that the retraining of the classifier model is continued until an optimal F1 measure is achieved on the training set and the classifier model at that point is selected for labeling the rest of the objects in the pool.

In the following examples, unless stated otherwise, experiments were performed on a Linux CentOS 6 server with 16 processing units and 36 GB of memory. In the following, beta-x: means a MMR β value of x or a threshold value T of x for LSH-with-Jumps.

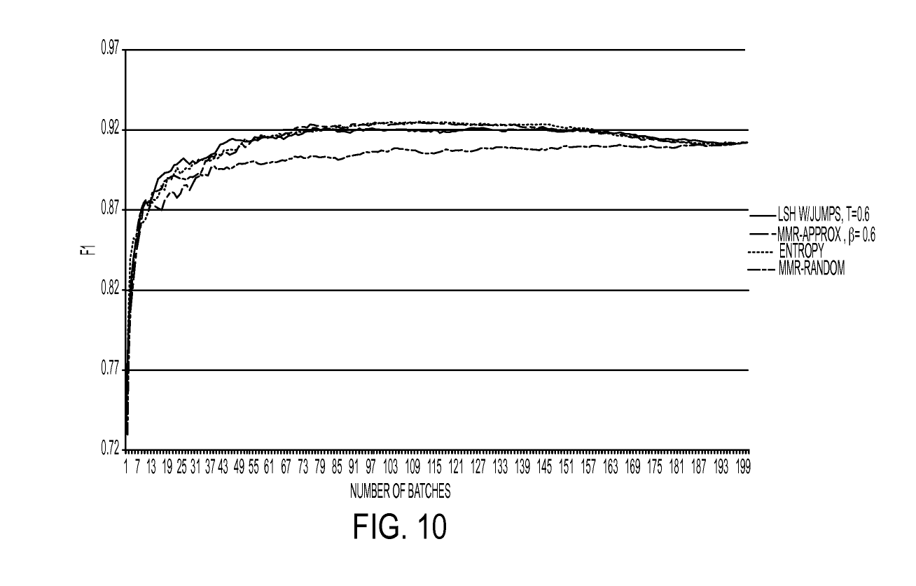

FIG. 10 shows results for 50 document-sized batches on 10,000 documents of Reuters Corpus V1, i.e., RCV1 (MMR-Approx., beta=0.6, LSH-with-Jumps, T=0.6, Entropy, and MMR-Random).

Similar experiments were performed for beta=0.4 and 0.2.

Looking at the results obtained, the LSH-with-Jumps method for batch active learning selection is:
More efficient in terms of memory consumption and processing time (5 to 6 times faster and 60% lighter than MMR).
Does not impact the overall performances of the system when compared with other techniques like the MMR selection.
Outperforms MMR in a sizeable proportion of the experiments with the best overall F1 and a better score in the first batches.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for selection of a batch of objects comprising:
for each object in a pool of objects:
performing Locality Sensitive Hashing on a multidimensional representation of the object to compute a signature comprising a sequence of elements;
segmenting the signature into a plurality of bands, each band comprising a subset of the elements in the signature;
assigning each of a plurality of bands of the signature to a respective one of a set of buckets based on values of the elements of the band;
computing an entropy value for each of a set of objects remaining in the pool using a current classifier model; and
selecting a batch of objects, including selecting objects from the set of objects based on their computed entropy values and respective assigned buckets,
wherein at least one of the performing Locality Sensitive Hashing, segmenting the signature, assigning the bands, computing an entropy value, and selecting the batch of objects is performed with a processor.

2. The method of claim 1, further comprising outputting the batch for labeling.

3. The method of claim 1, further comprising receiving labels for the objects in the batch, and retraining the classifier model based on the received labels.

4. The method of claim 3, further comprising:
removing the labeled objects from the pool;
repeating the computing of the entropy value for each of a set of objects remaining in the pool using the current classifier model, the current classifier model being the retrained classifier model; and
repeating the selecting a batch of objects from the set of objects remaining in the pool based on the computed entropy values of the objects in the pool and respective assigned buckets.

5. The method of claim 1, wherein the batch comprises at least 5 objects.

6. The method of claim 1, wherein the computing of the entropy H(d) comprises computing a function of Σ₁^{c}P(c|d)log_{c} P(c|d),
where c represents a class and P(c|d) represents the probability assigned for that class by the classifier model for the object d.

7. The method of claim 1, wherein the Locality Sensitive Hashing is performed with a family of at least 32 hash functions.

8. The method of claim 1, further comprising ranking the set of objects remaining in the pool based on their entropy values.

9. The method of claim 8, wherein the selection of objects in the batch includes drawing a new object from the pool based on its entropy value, comparing the entropy value of the new object with an entropy value of an object previously added to the batch and, if a difference in the entropy value does not exceed a threshold, comparing the assigned buckets of the new object with the assigned buckets of objects previously added to the batch and determining whether to add the new object to the batch based on the comparison.

10. The method of claim 9, wherein when the decision is not to add the new object to the batch, the method includes identifying the object remaining in the queue which has the highest entropy of the objects in the queue to be the next object.

11. The method of claim 1 wherein the method includes storing a list of the buckets of the objects already added to the batch and comparing the buckets of a new object drawn from the pool with the list of the buckets, the selecting of the batch of objects being based on the comparison.

12. The method of claim 1, wherein the objects are documents.

13. The method of claim 1, wherein the document representations are at least one of bag-of-words and bag-of-n-gram based representations.

14. The method of claim 1, further comprising using the retrained classifier model to label objects in the pool.

15. The method of claim 1, further comprising partitioning the pool of objects into a set of smaller pools, the selecting of the batch of objects including for each smaller pool:
selecting objects from the set of objects in the smaller pool based on their computed entropy values and respective assigned buckets;
and identifying the batch of objects based on the selected objects for each smaller pool.

16. A system for selection of a batch of objects comprising memory which stores instructions for performing the method of claim 1 and a processor in communication with the memory for executing the instructions.

17. A computer program product comprising non-transitory memory which stores instructions, which when executed by a computer, perform the method of claim 1.

18. A system for selection of a batch of objects comprising:
a classifier model training component for training a classifier model based on labeled objects;
a representation generator for providing representations of objects in a pool of objects;
an indexing component which indexes the objects of the pool based on signatures of the objects in the pool, the signatures having been segmented to form a plurality of bands, each band serving as a hash key to retrieve one of a plurality of buckets, the indexing being based on the buckets for which the bands are hash keys;
an entropy computation component which computes an entropy value for each of a set of objects remaining in the pool using a current classifier model;
a batch selection component for selecting objects to form a batch of objects from the set of objects in the pool based on the computed entropy values of the objects and respective assigned buckets; and
a processor which implements the classifier model training component, representation generator, indexing component, entropy computation component, and batch selection component.

19. The system of claim 18, further comprising a Locality Sensitive Hashing component for generating the signatures by Locality Sensitive Hashing.

20. A method for training a classifier comprising:
providing a current classifier model for labeling objects based on representations of the objects;
providing representations of objects in a pool of objects;
indexing the objects in the pool based on signatures of the objects, the signatures having been segmented to form a plurality of bands and each band assigned to one of a plurality of buckets, the indexing being based on the buckets to which the bands are assigned;
computing an entropy for each of a set of objects in a pool of objects with the current classifier model, based on the representations of the objects;
selecting a batch of objects, including selecting objects from the set of objects in the pool to form the batch of objects, the selection being based on the computed entropy values of the objects and respective assigned buckets; and
retraining the current classifier model with labels received for the objects in the batch to generate an updated classifier model,
wherein at least one of the indexing, computing an entropy value, selecting the batch of objects, and retraining the classifier model is performed with a processor.
